(19) United States
(12) Patent Application Publication
(10) Pub. No.: US 2012/0022949 A1
(43) Pub. Date: Jan. 26, 2012

(54) System and Method for Formulating a Life Plan

(76) Inventor: Jai GEORGE, Raleigh, NC (US)

(21) Appl. No.: 12/840,812

(22) Filed: Jul. 21, 2010

(51) Int. Cl. G06F 3/01; G06F 17/30; G06Q 30/00

(52) U.S. Cl. 705/14.66; 715/753; 707/769; 707/E17.014

(57) ABSTRACT

A method for formulating a life plan, the method steps including a user estimating how many years he or she has left before they believe they will become inactive; the user identifying desirable activities and goal; the user prioritizing desirable activities and consolidated goals in one-on-one comparisons; the computer ranking the consolidated goals highest to lowest based on the results of the one-on-one comparisons; the computer setting up a timeline to achieve the consolidated goals using the prioritized list and the estimated time left of question 1; the computer system placing the results in a project management and reminder system to assist the user in achieving his consolidated goals; the computer querying a life plan networking database to find other users whose timelines match the current users and presenting these matches for networking.

### BACKGROUND OF THE INVENTION

1. Field of the Invention

The present invention relates to life planning and, more specifically, to creating online communities of members that have similar life plans.

2. Description of the Prior Art

It is generally know in the prior art to provide social networking systems that provide a match based on compatibility of user interests. Social networking systems based on user-generated lists of interests and goals where the contents of the list are prioritized or ranked are also known.

U.S. Pat. No. 7,451,161; U.S. Pub. Nos. 2006/0247940 & 2009/0024548 for compatibility scoring of users in social networking, assigned to Friendster, Inc., describes a method of quantifying compatibility of interests or similarity in interests between members of a social network and providing a match based on the compatible interests. A set of individuals who are within a predetermined degree of separation from a first individual are taken and a compatibility score is computed between the first individual and each of the individuals in the set. Compatibility of the individuals is scored based on compatibility of interests, and these compatibility results and compatibility scores are presented to the individuals. Compatibility scores are linked to interest profiles, encouraging people to enter interests so the site can find other people who share the same or compatible interests.

U.S. Pat. No. 7,502,748 for a job matching system and method, assigned to Careerious Inc., describes a job matching system and method that utilizes personality profiles and candidate interests to match candidates to jobs. Employment position data is received from potential employers and individual candidate data is received from job candidates. The candidate data is compared with the employment position data to create a list of employment positions that match the candidate data. A score indicative of a candidates' suitability for a given employment opportunity is calculated from the comparison of the employment position data and individual candidate data

U.S. Pat. No. 7,617,160 for a choice-based relationship system (CRS), assigned to Grove, describes a system to connect event participants with other event participants having similar interests. The event may be a business conference, a cruise, a social gathering, or a virtual event. Profiles are created for the participants indicating preferences and characteristics of the participants. In response to an inquiry from a participant, profiles are compared and matches to other participants with similar interests are generated. This system allows the participants to connect with each other before, during, and after the event.

U.S. Pub. No. 2008/0288494 for a system enabling social networking through user-generated lists, describes a social networking method using user generated lists. A list database is generated based on the lists created or populated by users of the system. The list database may also include previously built lists or lists of publications, organizations, or groups. The method includes receiving a first list of items from a first user, receiving a second list of items from a second user. The determination of position of items in a third list includes performing a mathematical computation involving the first value corresponding to a first position of the first item in the first list and the second value corresponding to a second position of the first item in the second list. The third list is then displayed on the computer screen with items in that order. Users can generate a list (eg, favorite movies) and share the list with others who can then rank the list according to their own preferences. Users can also search or browse lists created by others.

U.S. Pub. No. 2009/0187829 for aggregation and visualization of reused shared lists, describes a shared list social networking system and provides for aggregating and visualizing reused shared lists. An example of a shared list is a rank-ordered list of likes or dislikes. Describes that users can select an existing shared list on a topic, view rank-ordered results, create a new shared list on the topic incorporating users individual rank-ordering of the shared list, and save the new shared list in association with the existing shared list. An aggregation view displays items for each rank or lists items in rank order based on the rankings of multiple users.

U.S. Pub. No. 2008/0162431 for identifying interest twins in an online community describes a method for identifying members in an online community with similar interests to other members of the online community, and determining if the users are “interest twins”. “Interest twins” are members that have demonstrated interest in the same or similar items. Member interests are identified by “interest-actions” such as following a link to a web page, bookmarking a web page, tagging items, playing or downloading videos, etc. Information on “interest twins” is used to enhance the experience of the user, such as ranking or highlighting search results from a search engine based on the interests of a user's “interest twin”. This invention does not appear to describe introductions or personal connections with “interest twins”.

U.S. Pub. No. 2009/0327270 for using variation in user interest to enhance the search experience describes a method to enhance the search experience by making the results list responsive to the interests of different individuals and groups of users. The system includes a search interface that determines the variability of search interests (e.g., goals) given queries, and a search experience enhancer. The search interface accepts a query from a user as input, and determines a variability in user interest (e.g. in search goals) for the query.

### SUMMARY OF THE INVENTION

The present invention relates to methods for formulating a life plan for a user. Furthermore, the present invention further relates to methods for finding other users with similar life plans and/or who will help a user reach his/her life goal.

It is an object of this invention to provide a method for formulating a life plan for a user.

It is an object of this invention to provide a system for implementing a method for formulating a life plan for a user.

It is another object of this invention to provide a system and method for finding users with matching life plans.

It is another objective of this invention to provide a system and method for finding users who will help with one's life plans.

Accordingly, a broad embodiment of this invention is directed to a life plan networking system that provides methods for a user to identify his/her life plan and to meet other users with similar life plans.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 is a schematic diagram of one embodiment of the invention.

FIG. 2 is a flow diagram of a method according to the present invention.

FIG. 3 is an example embodiment of software according to the present invention showing the personal and professional information input screen.

FIG. 4 is an example embodiment of software according to the present invention showing the fun/interest input screen.

FIG. 5 is an example embodiment of software according to the present invention showing the passion input screen.

FIG. 6 is an example embodiment of software according to the present invention showing the goals input screen.

FIG. 7 is an example embodiment of software according to the present invention showing the semantic analysis screen.

FIG. 8 is an example embodiment of software according to the present invention showing the goal prioritization screen.

FIG. 9 is an example embodiment of software according to the present invention showing the graphical timeline screen.

FIG. 10 is an example embodiment of software according to the present invention showing the goal achievement plan.

FIG. 11 is an example embodiment of software according to the present invention showing the permission-based life plan sharing screen.

FIG. 12 is an example of matching life plans created according to the present invention.

FIG. 13 is another example of matching life plans created according to the present invention.

### DETAILED DESCRIPTION

Referring now to the drawings in general, the illustrations are for the purpose of describing a preferred embodiment of the invention and are not intended to limit the invention thereto.

The present invention provides for a system and method for formulating a life plan for a user. The present invention further provides for a system and method for finding other users with similar life plans.

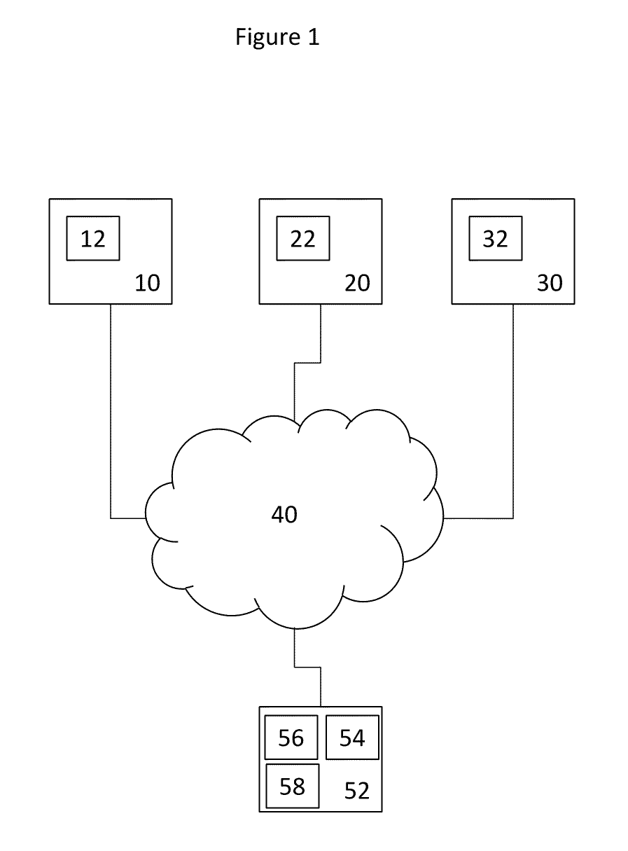

As shown in FIG. 1, the system 100 comprises a server 110 with a processing unit 111. The server 110 is constructed, configured and coupled to enable communication over a network 150. The server provides for user interconnection with the server over the network using a personal computer (PC) 140 positioned remotely from the server. Furthermore, the system is operable for a multiplicity of remote personal computers or terminals 160, 170. For example, in a client/server architecture, as shown. Alternatively, a user may interconnect through the network 150 using a user device such as a personal digital assistant (PDA), mobile communication device, such as by way of example and not limitation, a mobile phone, a cell phone, smart phone, laptop computer, netbook, a terminal, or any other computing device suitable for network connection. Also, alternative architectures may be used instead of the client/server architecture. For example, a PC network, or other suitable architecture may be used. The network 150 may be the Internet, an intranet, or any other network suitable for searching, obtaining, and/or using information and/or communications.

The system of the present invention further includes an operating system 112 installed and running on the server 110, enabling server 110 to communicate through network 150 with the remote, distributed user devices. The operating system may be any operating system known in the art that is suitable for network communication.

A memory 120 is interconnected with the server 110. Memory 120 may be integral with server 110 or may be external to the server and interconnected therewith. A life plan program 122 is stored on memory 120. According to an exemplary embodiment, the life plan program 122 is computer executable code for using information derived from user inputs to develop a life plan. Alternatively, portions of the life plan program 122 or the whole life plan program may be installed on a user's computing device 140.

A user may connect to the server 110 through network 150 from a computing device 140. According to an exemplary embodiment, computing device 140 is a personal computer. Computing device 140 is interconnected to the network 150 such as through a modem, an Ethernet card, or the like. A processing unit 144 may be interconnected with a memory 146. The computing device 140 may also comprise one or more input/output devices 148, such as a mouse, a keyboard, a printer, and the like interconnected to the processing unit 144. A display 149, 169, 179 may be interconnected with the respective processing units for providing a graphical user interface.

Computing device 140 may have a program of instruction 147, such as a driver enabling computing device 140 to interconnect with server 110 through network 150.

Regarding methods using the system, the user uses inputs information into the memory 120, the server 110 creates and updates a profile database 122. The server then executes the parsing 124, semantic indexing 126 and decision programs 128 stored in memory 120. The parsing and semantic indexing programs use the inputs provided by the user to build a life plan. The server stores the life plan in memory 120.

The decision engine 128, then uses the life plan to build a life plan network based on those interests. This life plan network may be temporal, automatically being disbanded upon some completion event, such as the user logging out, or the user responding positively to a prompt to terminate the life plan network. Alternatively, the life plan network may remain in effect until proactively terminated by the user. Optionally, other users with common interests may be prompted as to whether or not they wish to join the life plan network, and added only if they take an acceptance action.

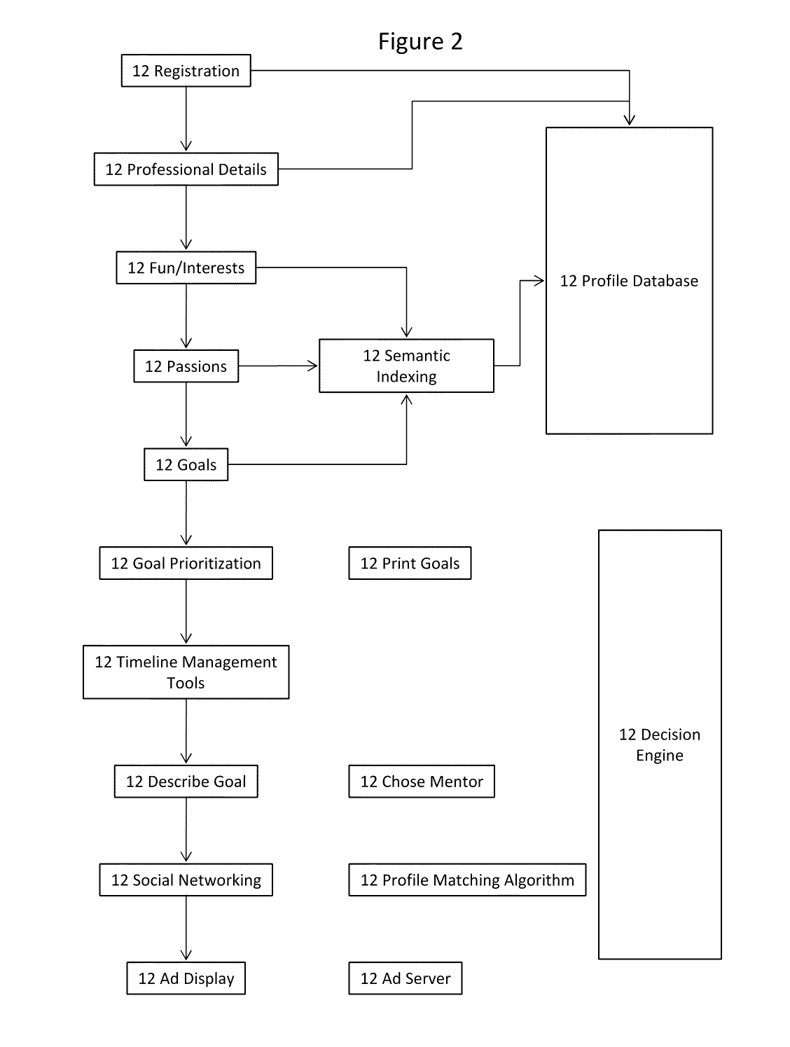

FIG. 2 is a process flow diagram illustrating a method of formulating a life plan according to the present invention.

The method for formulating a life plan includes the following method steps:

The system receiving inputs provided by a remote user for registering that user, including creating an unique user identification, including by way of example and not limitation a user login and a user passcode (step 410) and the system further receiving inputs from the user including inputs for personal and professional information (step 415), such as age, location, profession, and the like.

The system receiving inputs provided by a remote user estimating how many years he or she has left before they believe they will become inactive or retire (step 420). “Estimated years left” is personally estimated from the moment of formulating the life plan, not based on any future achievement.

The system automatically parsing the personal and professional information and estimated years left (step 422) into the profile database 122.

The system receiving inputs provided by a remote user identifying activities that they perceive to be fun (step 425), without regard to financial situation of the user at that time.

The system receiving inputs provided by a remote user identifying activities that they are passionate about (step 430).

The system receiving inputs provided by a remote user identifying personal and professional goals (step 435).

The system automatically transforming the user's inputs into an user profile, which is then stored in the system database, the transformation steps further including the following:

The system performing a semantic/similarity indexing (step 437) of the lists to identify activities and goals on more than one list and updating the user's profile. Semantic indexing of words would provide a system where when certain words are entered into the system, the library of indexed words would do a matching to see if there are other words to gauge what the user is attempting to input.

An example would be, if a user inputs basketball as his fun, then words like “sports” and “NBA” would be shown to the user in an attempt to bring clarity to the user.

The similarity words feature would look for stemmed common words to see its appearance in Fun, Passion and Goals to highlight the intensity of the user's life goals with respect to those words.

The system automatically associating related activities and goals, to collapse or consolidate them into at least one goal item to form a list of consolidated goals.

The system automatically presenting the remote user via the interactive GUI on a display at the user location with one-on-one comparisons of consolidated goals and the user prioritizing the consolidated goals (step 440).

Then, the system automatically ranking the consolidated goals highest to lowest based on the inputs by the user for results of the one-on-one comparisons. This method of ranking gives a more accurate and honest prioritization than having the user prioritize all the consolidated goals simultaneously. The prioritization process continues until the user is clear with the order of his consolidated goals, without contradiction of rankings.

Once clear, the list of prioritized, consolidated goals is saved in the database in association with that user, and may be printed remotely at the user location, as a reminder (step 445);

The system automatically generating a graphical timeline (step 450) to achieve the consolidated goals using the prioritized list and the estimated time left of question 1. The timeline is made by distributing the prioritized, consolidated goals on the estimated time left. The graphical timeline is an interactive slider where the user can click on a life goal and set a specific date to achieve it. The user can click on each of the life goals represented graphically and dragged back and forth until all of the life goals have been set with specific dates.

The system automatically transforming these results into a project management system with automatic reminders being provided to the user, to assist the user in achieving his consolidated goals (step 455). These automatic reminders may be provided in a variety of means, including but not limited to email notification, calendar invitation to electronic calendar via email, SMS or text message, facsimile, phone call or voice mail, and combinations thereof. This transformed list of prioritized, consolidated goals with reminders based upon the timeline of the user prioritization and completion gives the user a clear view of his consolidated goals with corresponding timing.

The system receiving inputs from the remote user describing their consolidated goals in more details and how they plan to achieve them through actionable plan (step 460);

The system receiving inputs from the remote user optionally choosing a life coach or a mentor from the list or suggesting a new mentor to whom they want to be accountable to get their consolidated goals achieved (step 465).

The system automatically querying a life plan network database associated and/or coupled with the system, to find other users whose consolidated goals and timelines match and/or are synergistic to that particular user's consolidated goals and timelines (step 470). Importantly, the present invention provides for an automatic coupling of consolidated goals and timelines for each user; while these are modifiable based upon user inputs, the consolidated goals are always coupled with a timeline or deadline for achievement or completion; If a match is found, then the system automatically provides for a permission-based life plan sharing (step 475) via cohort groups connecting related users, based upon the consolidated goals and associated timelines. The system is operable to receive inputs from the user(s) for selecting a group of cohorts and use this cohort group for support and as a comparison to determine their progress in accomplishing his life plan.

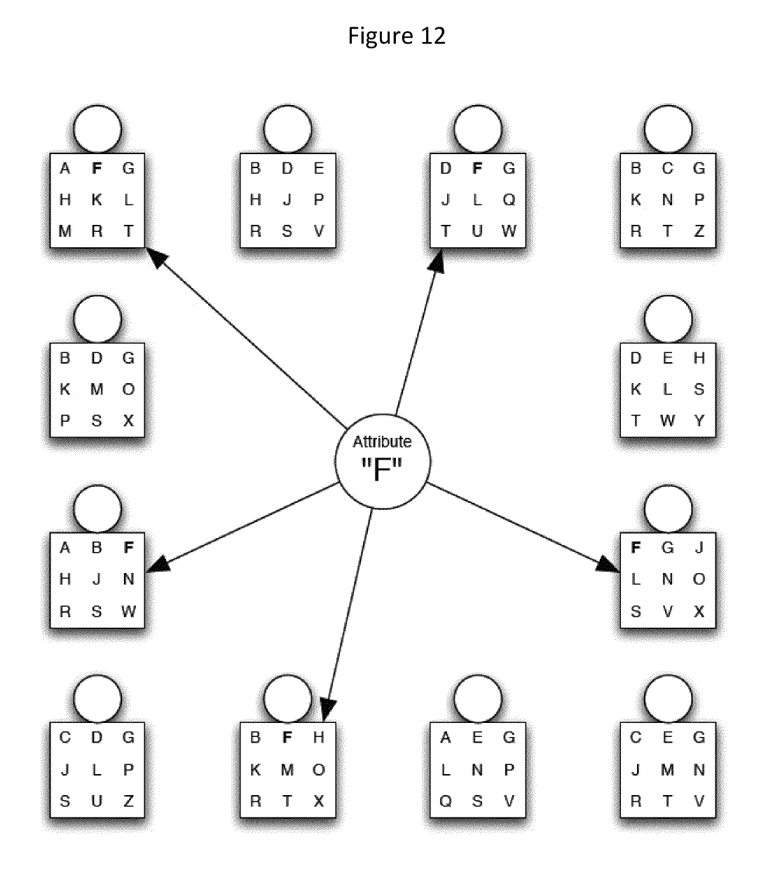

Various methods for matching life plans can be used. FIG. 12 shows a simple method to matching life plans. Every person's life plan has many attributes, such as their interests, passions, and goals. Our present invention allows users to connect with other users who have similar or matching life plan attributes. An individual with an attribute “F” (such as a love of travel or the desire to date, for example) would be matched to other individuals who also have attribute “F” or attributes similar to “F”.

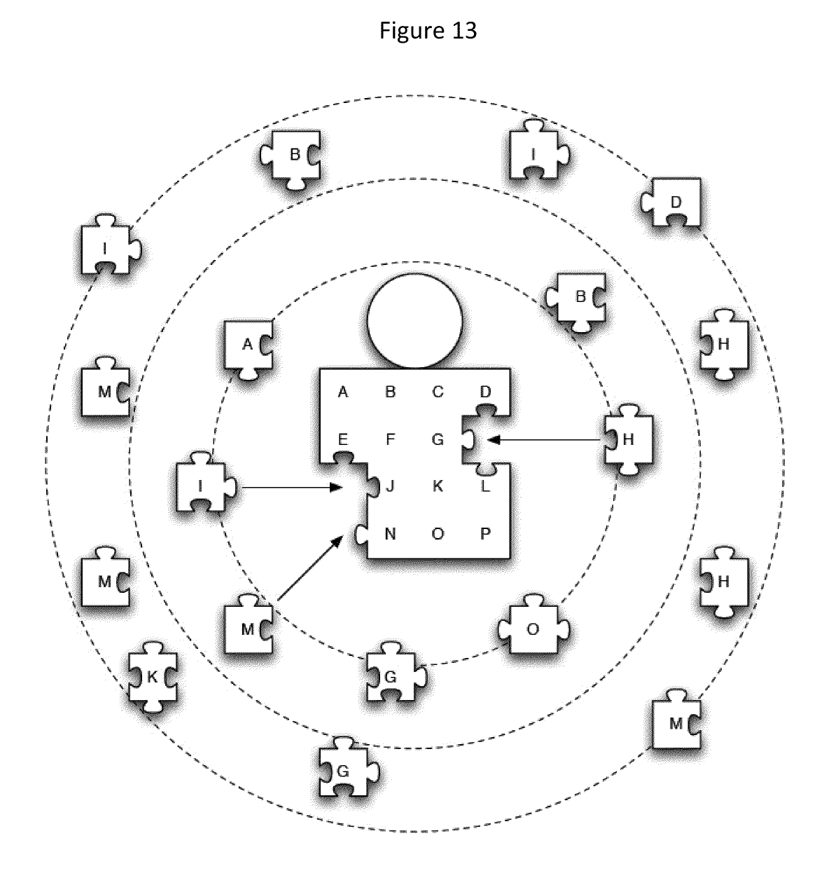

FIG. 13 shows a more elaborate method to matching life plans. In this method, the present invention identifies goals that a person wishes to accomplish in, and interests or passions that a person wishes to engage in, but does not possess all the resources necessary to do so. The system then matches that person to the database members best able to provide the resources he or she lacks. For a given interest, passion, and/or goal, a method according to the present invention will: (1) determine what resources are needed; (2) evaluate the resources currently available to the individual; (3) identify which resources are missing; (4) querying a life plan networking database to find members who can provide the missing resources; and (5) rank those members by geographic, cultural, and ideological proximity to the individual.

After achieving a goal, the user notes the goal in their profile and then returns to step 1 and repeats the process to re-evaluate their life plan. Alternatively, the user can continue with the same life plan.

Yet another method for matching life plans is to search for matches wherein two users synergize by providing to one another the missing resources. Thus, the two users will exchange resources directly, thereby synergizing with each other in their quest to achieve their goals.

The decision engine analyzing a user's profile words to match products, opportunity, connections, jobs, etc. to help users achieve their consolidated goals (step 480) and suggesting goods and services to assist the user in achieving his consolidated goals (step 485).

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention may take the form of a computer program product accessible from a computer-usable or computer-readable medium providing program code for use by or in connection with a computer or any instruction execution system or device. For the purposes of this description, a computer-usable or computer readable medium may be any apparatus that can contain, store, communicate, propagate, or transport the program for use by or in connection with the instruction execution system, apparatus, or device.

The foregoing method may be realized by a program product comprising a machine-readable media having a machine-executable program of instructions, which when executed by a machine, such as a computer, performs the steps of the method. This program product may be stored on any of a variety of known machine-readable media, including but not limited to compact discs, floppy discs, USB memory devices, and the like. Moreover, the program product may be in the form of a machine readable transmission such as blue ray, HTML, XML, or the like.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk an optical disk. Current examples of optical disks include compact disk-read only memory (CD-ROM), compact disk-read/write (CD-R/W) and DVD.

Referring now to the examples, in general, these examples are for illustrations for the purpose of describing a preferred embodiment of the invention and are not intended to limit the invention thereto.

A person, male, aged 49, was administered the following questionnaire:

Question 1. How many years do you believe you have left before you will become inactive? The person, aged 49, believed he would become inactive at 70 years of age, giving him 21 remaining years of activity.

Question 2. What activities do you perceive to be fun? The person identified the following: travel to see new places and large cities, vacationing at the beach and mountains; family activities such as hiking and camping; reading science fiction, fantasy, adventure, especially Westerns; eating new foods; hang gliding, snow skiing, water sports and adventure sports.

Question 3. What activities are you passionate about? The person identified reading science magazines; learning about new technology; trading stocks.

The semantic engine then cross-compares between the results of question 2 and question 3 to determine the activities that are most likely to be truly pleasurable to the user.

In this example the only similarity words are reading, science, adventure and sports.

Question 4. What are your personal and professional goals? The person identified the following goals: unity in his family, including better understanding with his wife; seeing the world; creating, buying or run a profitable new business; seeing his children marry; be a better man than his father was; bless others; and participate in community development in Asia.

Related activities, vacations and goals from questions 2, 3, and 4 are associated by the semantics engine and similar answers collapsed to form a list of consolidated goals.

After semantic indexing the highlighted words are: Travel, vacations, science magazine, sports and adventure.

The method then asks the user to prioritize the list of consolidated goals by comparing them on a one-to-one basis and choosing the activity they prefer. The user responds with the following order:

The results of the top five consolidated goals are as follows: 1) unity with wife; 2) see the world; 3) bless others; and 4) see children get married and be successful. More goals can be allowed. For example, up to ten goals may be allowed.

The prioritized list is then placed on a timeline. This transformed list of prioritized, consolidated goals with timing gives the user a clear view of his consolidated goals with corresponding timing. The timing can be adjusted at this time by the user. The results are then placed in a project management and reminder system to assist the user in achieving his consolidated goals.

The prioritized, timed plan is then compared to other such plans in a life plan networking database. The plans are matched for consolidated goals and timing.

A similarity matching is done between users based on the words that describe a user's fun, passion and goals.

The users are then sorted based on the most matching to least matching.

An example would be a user finding another user who has the passion and interest to go fishing.

Another example of connection would be user A has the life goal of starting a technology company and user B has the life goal of investing in a technology company. Matches are presented to the user, who can request permission-based life plan sharing with the matching users at the present time or at a future time.

Thus, the present invention includes a system and method for formulating a life plan, including a server having a processing unit operable over a network for connecting with a multiplicity of remote users via remote user terminals each having a display and interactive graphic user interface (GUI); the system operable for receiving the following user inputs and processing according to the following method steps:
a. a user estimating how many years he or she has left before they believe they will become inactive;
b. the user identifying activities or vacations that they perceive to be fun;
c. the user identifying activities that they are passionate about;
d. the user identifying personal and professional goals;
e. the computer collapsing similar activities, vacations and goals into a list of consolidated goals;
f. the computer presenting the consolidated goals in one-on-one comparisons to the user for ranking by the user;
g. the computer ranking the consolidated goals highest to lowest based on the results of the one-on-one comparisons;
h. the computer setting up a timeline to achieve the consolidated goals using the prioritized list and the user's estimated time left;

thereby providing a system and method for formulating a life plan.

The system and method may further include the steps of the user modifying the timeline according to personal preference; the system querying a life plan networking database to find other users whose timelines match the current users; allowing permission-based life plan sharing for users with matching life plans; the user selecting a group of cohorts and using this cohort group for support and as a comparison to determine their progress in accomplishing his life plan; the user noting an achieved goal in their profile and then returning to step 1 and repeating the process to re-evaluate their life plan; the system placing the results in a project management and reminder system to assist the user in achieving his consolidated goals; the system presenting mentor choices to the user; and the system selecting and presenting goods and services to the user based upon the life plan.

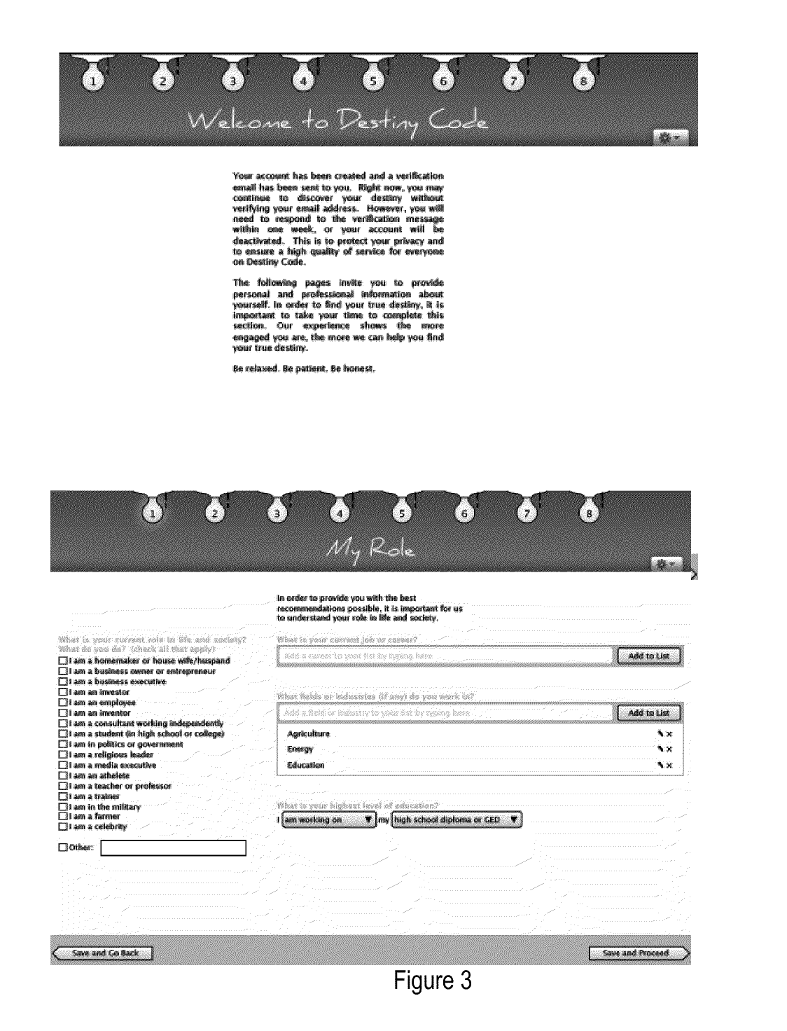

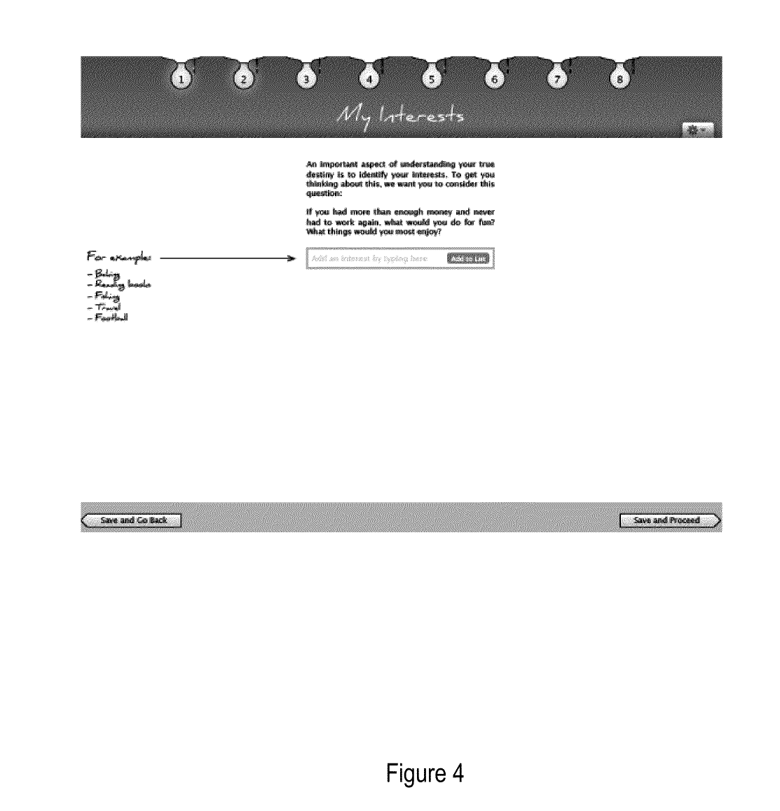

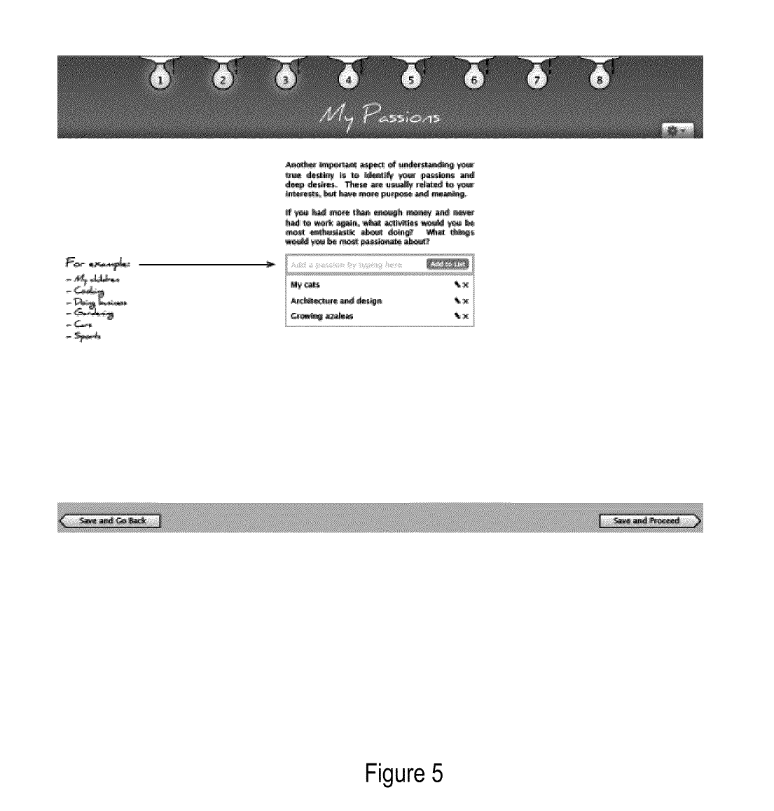

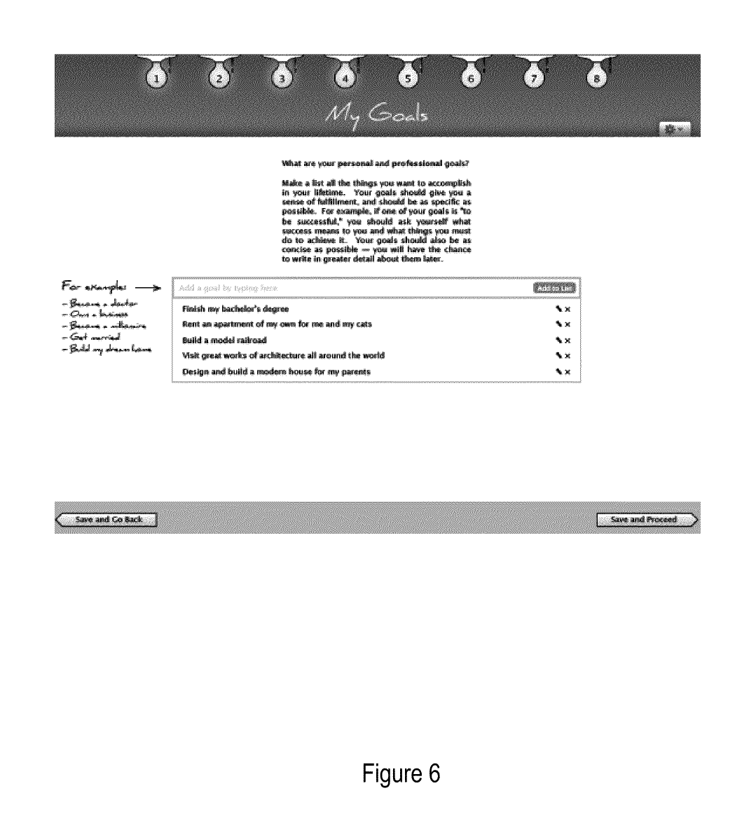

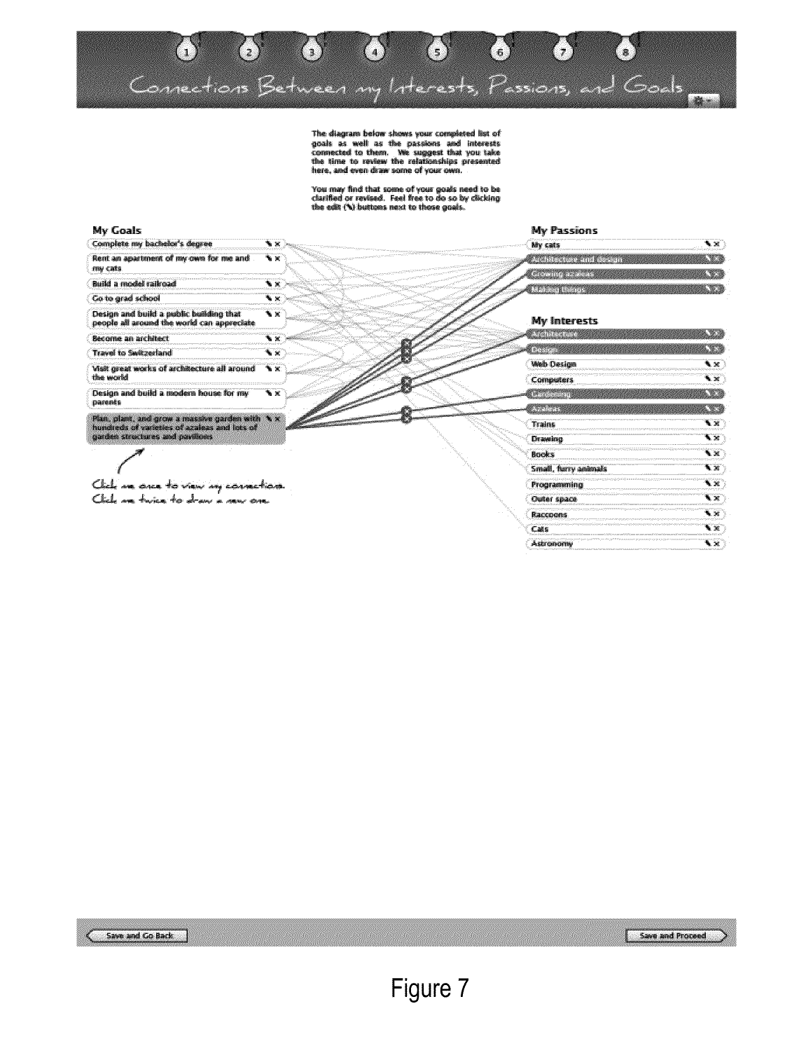

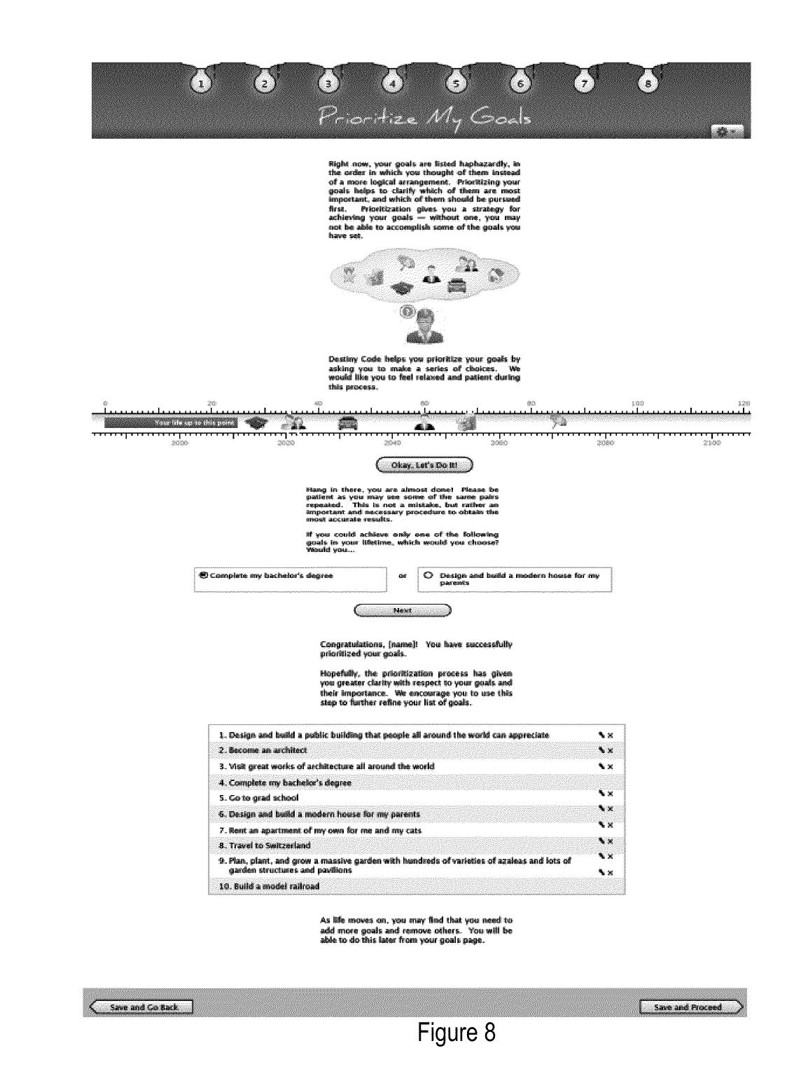

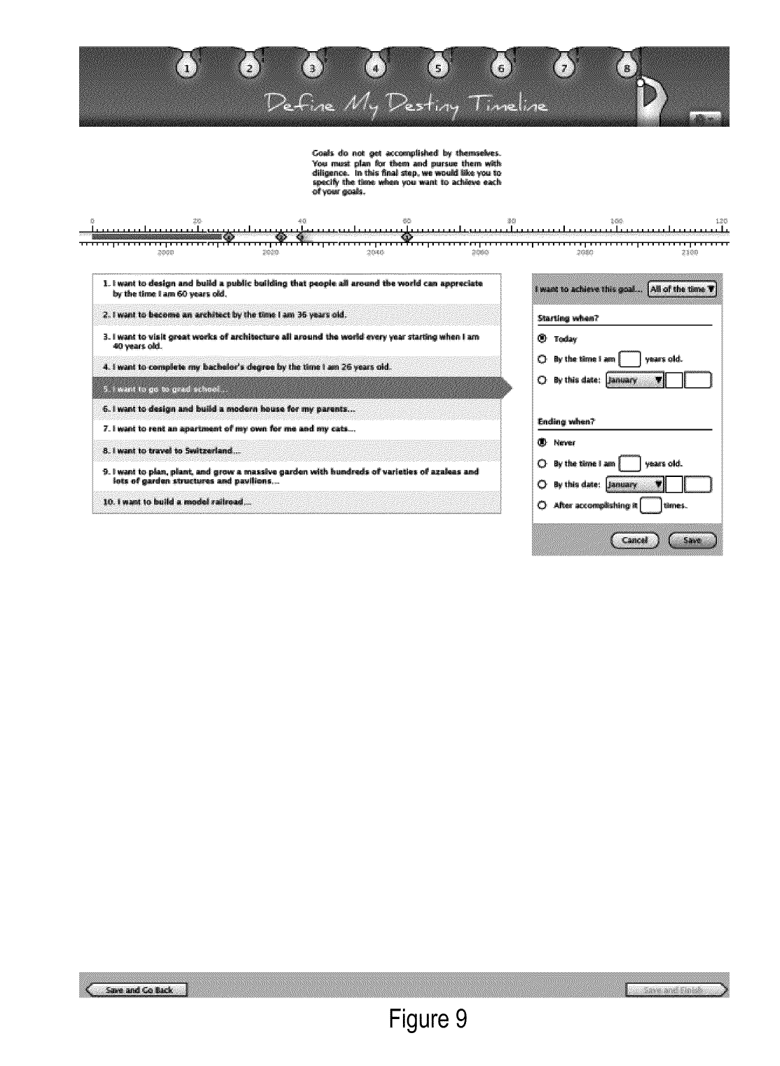

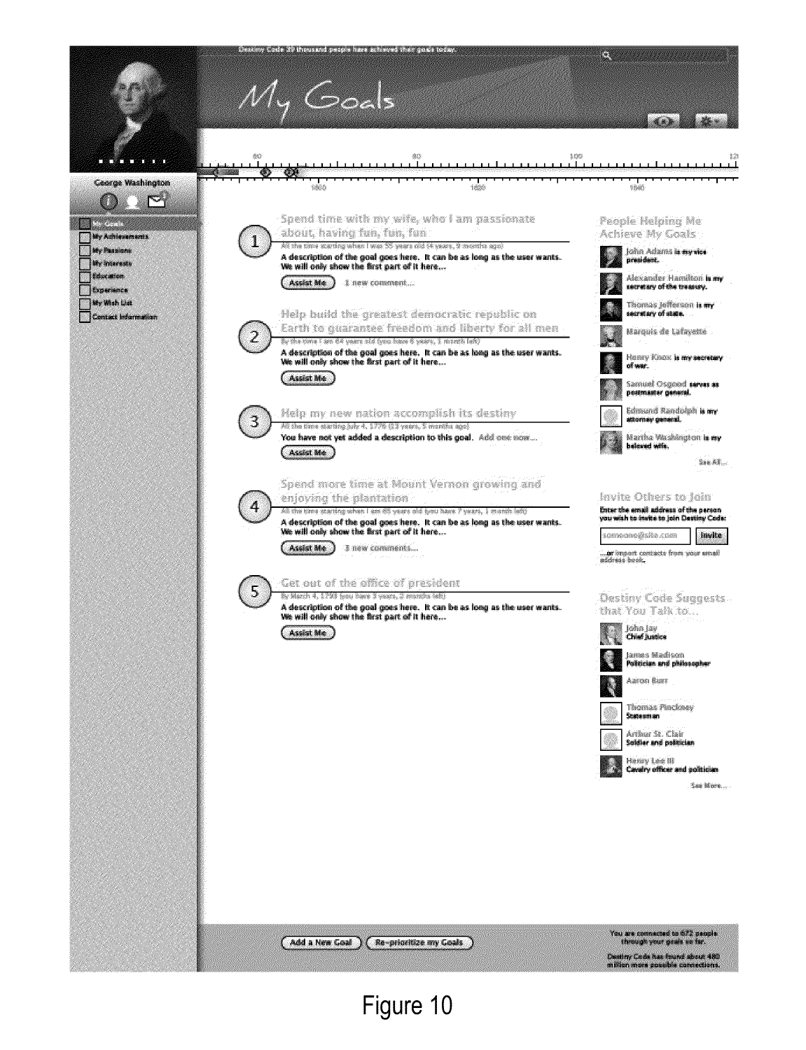

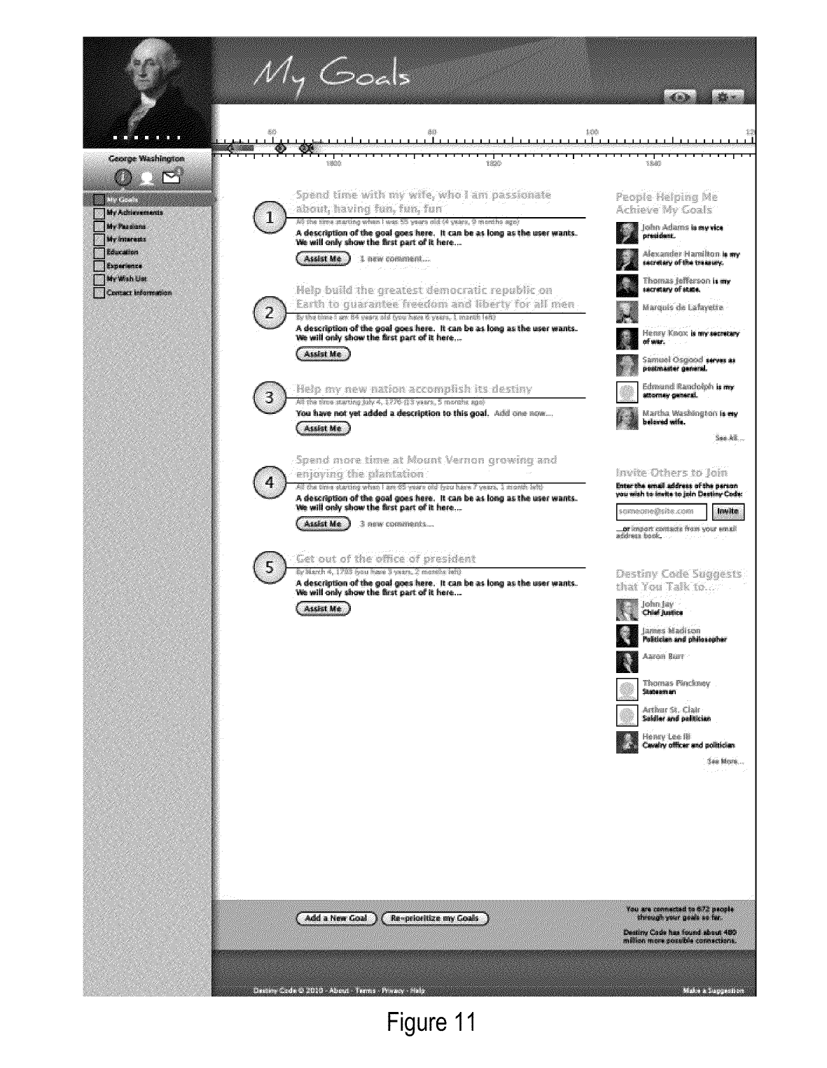

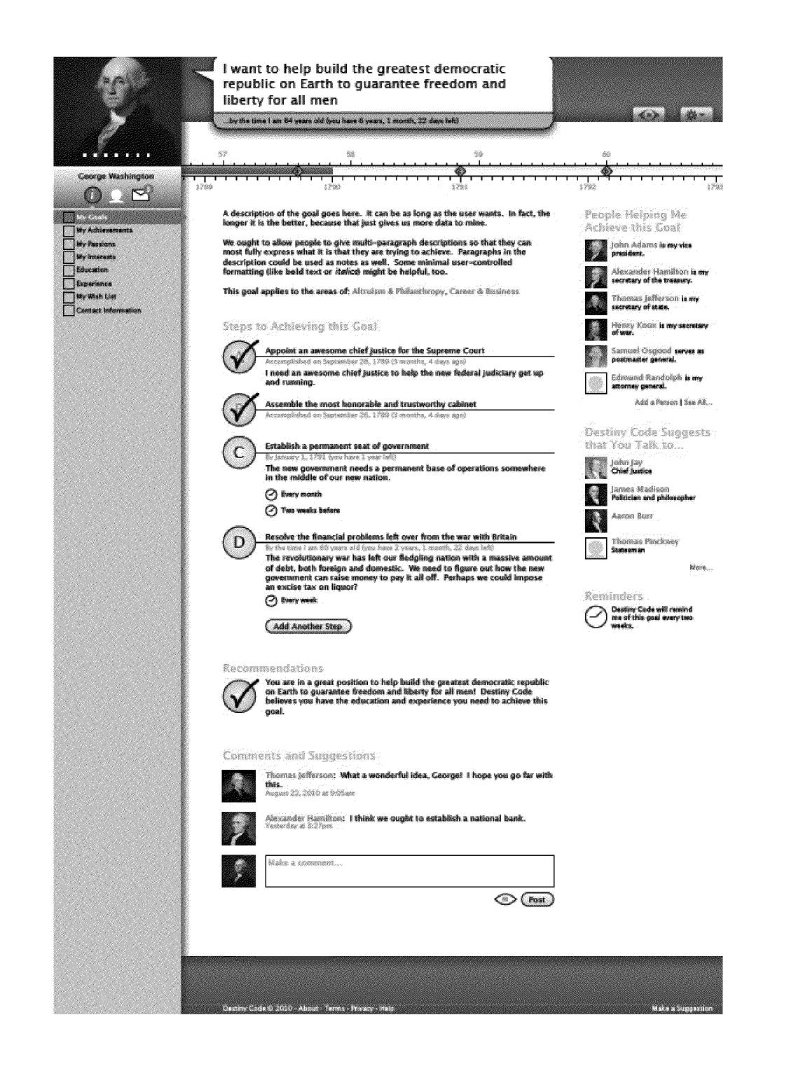

Another example embodiment of the process is shown in FIGS. 3 through 12. FIG. 3 shows the personal and professional information input screen. FIG. 4 shows the fun/interest input screen. FIG. 5 shows the passion input screen. FIG. 6 shows the goals input screen. FIG. 7 shows the semantic analysis screen. FIG. 8 shows the goal prioritization screen. FIG. 9 shows the graphical timeline screen. FIG. 10 shows the goal achievement plan. FIG. 11 shows the permission-based life plan sharing screen.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

What is claimed is:

1. A method for formulating a life plan, the method steps including:
a. providing a server having a processing unit operable over a network for connecting with a multiplicity of remote users via remote user terminals each having a display and interactive graphic user interface (GUI); the system operable for receiving user inputs and processing them;
b. a user estimating how many years he or she has left before they believe they will become inactive;
c. The user identifying activities that they perceive to be fun;
d. The user identifying activities that they are passionate about;
e. The user identifying personal and professional goals;
f. The computer collapsing similar activities and goals into a list of consolidated goals;
g. The user prioritizing the consolidated goals in one-on-one comparisons;
h. The computer ranking the consolidated goals highest to lowest based on the results of the one-on-one comparisons;
i. The computer setting up a timeline to achieve the consolidated goals using the prioritized list and the estimated time left;
thereby providing a method for formulating a life plan.

2. The method of claim 1, further including the step of the user modifying the timeline according to personal preference.

3. The method of claim 1, further including the step of the system querying a life plan networking database to find other users whose life plan attributes match the current user's life plan attributes.

4. The method of claim 3, further including the step of the system finding life plan matching users by:
a. determining what resources are needed by a user;
b. evaluating the resources currently available to the individual;
c. identifying which resources are missing;
d. querying a life plan networking database to find users who can provide the missing resources; and
e. ranking those members by geographic, cultural, and ideological proximity to the individual.

5. The method of claim 4, further including the step of the system finding life plan matching users by search for matches wherein two users synergize by providing to one another the missing resources.

6. The method of claim 3, further including the step of allowing permission-based life plan sharing for users with matching life plans.

7. The method of claim 1, further including the step of the user selecting a group of cohorts and using this cohort group for support and as a comparison to determine their progress in accomplishing his life plan.

8. The method of claim 1, further including the step of the user noting an achieved goal in their profile and then returning to step 1 and repeating the process to re-evaluate their life plan.

9. The method of claim 1, further including the step of the computer system placing the results in a project management and reminder system to assist the user in achieving his consolidated goals.

10. The method of claim 1, further including the step of the system presenting mentor choices to the user.

11. The method of claim 1, further including the step of the system selecting and presenting goods and services to the user based upon the user's life plan.

12. A system for formulating a life plan, comprising: a server having a processing unit operable over a network for connecting with a multiplicity of remote users via remote user terminals each having a display and interactive graphic user interface (GUI); the system operable for receiving the following user inputs and processing them as follows:
a. a user estimating how many years he or she has left before they believe they will become inactive;
b. the user identifying activities or vacations that they perceive to be fun;
c. the user identifying activities that they are passionate about;
d. the user identifying personal and professional goals;
e. The computer collapsing similar activities, vacations and goals into a list of consolidated goals;
f. the computer presenting consolidated goals in one-on-one comparisons to the user for ranking by the user;
g. the computer ranking the consolidated goals highest to lowest based on the results of the one-on-one comparisons;
h. the computer setting up a timeline to achieve the consolidated goals using the prioritized list and the user's estimated time left;
thereby providing a system for formulating a life plan.

13. The system of claim 12 further including the step of the user modifying the timeline according to personal preference.

14. The system of claim 12, further including the steps of the system querying a life plan networking database to find other users whose life plan attributes match the current users.

15. The method of claim 14, further including the step of the system finding life plan matching users by:
a. determining what resources are needed by a user;
b. evaluating the resources currently available to the individual;
c. identifying which resources are missing;
d. querying a life plan networking database to find users who can provide the missing resources; and
e. ranking those members by geographic, cultural, and ideological proximity to the individual.

16. The method of claim 15, further including the step of the system finding life plan matching users by search for matches wherein two users synergize by providing to one another the missing resources.

17. The system of claim 14, further including the step of allowing permission-based life plan sharing for users with matching life plans.

18. The system of claim 12, further including the step of the user selecting a group of cohorts and using this cohort group for support and as a comparison to determine their progress in accomplishing his life plan.

19. The system of claim 12, further including the step of the user noting an achieved goal in their profile and then returning to step 1 and repeating the process to re-evaluate their life plan.

20. The system of claim 12, further including the step of the computer system placing the results in a project management and reminder system to assist the user in achieving his consolidated goals.

21. The method of claim 12, further including the step of the system presenting mentor choices to the user.

22. The method of claim 12, further including the step of the system selecting and presenting goods and services to the user based upon the user's life plan.
